(19) United States
(12) Patent Application Publication
(10) Pub. No.: US 2010/0214309 A1
(43) Pub. Date: Aug. 26, 2010

(54) METHOD OF GENERATING A COMMON VOLTAGE FOR DRIVING A DISPLAY PANEL, DISPLAY PANEL DRIVING APPARATUS FOR PERFORMING THE METHOD AND DISPLAY APPARATUS HAVING THE DISPLAY PANEL DRIVING APPARATUS

(75) Inventors: Min-Seok Bae, Yongin-si (KR); Hye-Sung Kim, Busan (KR); Dae-Kyun Oh, Jincheon-gun (KR); Ji-Young Kim, Seoul (KR); Jong-Seok Chae, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/710,657

(22) Filed: Feb. 23, 2010

(30) Foreign Application Priority Data
Feb. 26, 2009 (KR) 2009-0016210

(51) Int. Cl. G06F 3/038; G09G 5/36; G09G 5/02; G09G 3/20

(52) U.S. Cl. 345/589; 345/211; 345/545; 345/55

(57) ABSTRACT

A method of generating a common voltage for driving a display panel includes; comparing image data of a previous frame with image data of a present frame to determine whether the image data of the previous frame, which is received during a first setting time, is substantially the same as the image data of the present frame, determining a voltage level of the common voltage applied to the display panel in accordance with whether the image data of the previous frame is substantially the same as the image data of the present frame, generating the common voltage corresponding to the determined voltage level, and providing the display panel with the common voltage.

This application claims priority to Korean Patent Application No. 2009-16210, and all the benefits accruing therefrom under 35 U.S.C. §119, the contents of which in its entirety are herein incorporated by reference.

### BACKGROUND OF THE INVENTION

1. Field of the Invention

Exemplary embodiments of the present invention relate to a method of generating a common voltage for driving a display panel, a display panel driving apparatus for performing the method, and a display apparatus having the display panel driving apparatus. More particularly, exemplary embodiments of the present invention relate to a method of generating a common voltage for driving a display panel used in a display apparatus, a display panel driving apparatus for performing the method, and a display apparatus having the display panel driving apparatus.

2. Description of the Related Art

Generally, a liquid crystal display (“LCD”) apparatus includes an LCD panel displaying an image using the light transmittance characteristics of liquid crystal molecules, and a backlight assembly disposed below the LCD panel to provide the LCD panel with light.

The typical LCD apparatus includes a display panel including a plurality of gate lines and a plurality of data lines disposed substantially perpendicular to the gate lines, a gate drive circuit outputting gate signals to the gate lines, and a data drive circuit outputting data signals to the data lines. A plurality of pixels is defined by the plurality of data lines and the plurality of gate lines. In an active matrix display, each of the pixels includes a switching element electrically connected to the gate lines and the data lines and a pixel electrode electrically connected to the switching element.

A kickback voltage is generated due to a parasitic capacitance Cgd generated between a gate electrode and a drain electrode of the switching element, and causes a distortion of the data voltage applied to the pixel electrode.

The kickback voltage is differed in accordance with a gray scale of the applied data voltage. Image sticking, wherein an existing image remains in the form of afterimages, may be caused when a substantially similar image is displayed on the display panel during a predetermined time and then the image is converted into a new pattern image. Accordingly, the display quality of an image may be deteriorated.

### SUMMARY OF THE INVENTION

Exemplary embodiments of the present invention provide a method of generating a common voltage for driving a display panel capable of improving display quality.

Exemplary embodiments of the present invention also provide a display panel driving apparatus suitable for performing the above-mentioned method.

Exemplary embodiments of the present invention further also provide a display apparatus having the above-mentioned display panel driving apparatus.

According to one exemplary embodiment of the present invention, a method of generating a common voltage for driving a display panel includes comparing image data of a previous frame with image data of a present frame to determine whether the image data of the previous frame, which is received during a first setting time, is substantially the same as the image data of the present frame, determining a voltage level of the common voltage applied to the display panel in accordance with whether the image data of the previous frame is substantially the same as the image data of the present frame, generating the common voltage corresponding to a determined voltage level; and providing the display panel with the common voltage.

In an exemplary embodiment of the present invention, comparing image data of a previous frame with image data of a present frame is performed during a second setting time.

In an exemplary embodiment of the present invention, determining the voltage level of the common voltage includes; increasing a count value may be increased when the image data of the previous frame is substantially the same as the image data of the present frame, and comparing the count value with a predetermined setting value after a second, determining the voltage level f the common voltage to be a common voltage level corresponding to a gray scale of the image data of the present frame when the count value is equal to or greater than the predetermined setting value.

In an exemplary embodiment of the present invention, determining the voltage level of the common voltage further may include resetting the count value when the image data of the previous frame is different from the image data of the present frame.

In an exemplary embodiment of the present invention, determining the voltage level of the common voltage includes determining the voltage level of the common voltage to be an initial voltage level when the count value is less than the predetermined value.

According to another exemplary embodiment of the present invention, a display panel driving apparatus includes; a common voltage determining circuit which compares image data of a previous frame with image data of a present frame to determine whether the image data of the previous frame received during a first setting time is substantially the same as the image data of the present frame, and determining which determines a voltage level of a common voltage applied to a display panel in accordance with whether the image data of the previous frame is substantially the same as the image data of the present and a voltage generating part which generates the common voltage corresponding to the determined voltage level to provide the display panel with the common voltage.

In an exemplary embodiment of the present invention, the common voltage determining circuit may compare the image data of the previous frame with the image data of the present frame during a second setting time.

In an exemplary embodiment of the present invention, the common voltage determining circuit may include; a buffer memory which stores the image data of the previous frame, a graphic memory which stores the image data of the present frame and a main control part which determines the voltage level of the common voltage to be a common voltage level corresponding to a gray scale of the image data of the present frame when the image data of the previous frame is substantially the same as the image data of the present frame during the first setting time.

In an exemplary embodiment of the present invention, the main control part may determine the voltage level of the common voltage to be an initial level when the image data of the previous frame is different from the image data of the present frame during the first setting time.

In an exemplary embodiment of the present invention, the display panel driving apparatus may further include a representative luminance value calculating part which analyzes the image data stored in the graphic memory to calculate a representative luminance value, and wherein the main control part may determine a gray scale of the image data of the present frame using the representative luminance value.

In an exemplary embodiment of the present invention, the common voltage determining circuit may further include a counter which outputs a count value, and the main control part may control the counter to increase the count value when the image data of the previous frame is substantially the same as the image data of the present frame.

In an exemplary embodiment of the present invention, the main control part may output a reset signal to the counter to reset the count value when the image data of the previous frame is different from the image data of the present frame.

In an exemplary embodiment of the present invention, the main control part may compare the count value with the determined setting value, and when the count value is less than the predetermined value to the main control part determines the image data of the previous frame is substantially the same as the image data of the present frame during the first setting time.

According to still another exemplary embodiment of the present invention, a display apparatus includes; a display panel which displays an image and a display panel driving apparatus which includes a common voltage determining circuit which compares image data of a previous frame with image data of a present frame to determine whether the image data of the previous frame received during a first setting time is substantially the same as the image data of the present frame, and which determines a voltage level of a common voltage applied to the display panel in accordance with whether the image data of the previous frame is substantially the same as the image data of the present frame, and a voltage generating part which generates the common voltage corresponding to a determined voltage level to provide the display panel with the common voltage.

In an exemplary embodiment of the present invention, the common voltage determining circuit may compare the image data of the previous frame with the image data of the present frame during a second setting time.

In an exemplary embodiment of the present invention, the common voltage determining circuit may include a buffer memory which stores the image data of the previous frame, a graphic memory which stores the image data of the present frame and a main control part which determines the voltage level of the common voltage to be a common voltage level corresponding to the gray scale of the image data of the present frame when the image data of the previous frame is substantially the same as the image data of the present frame during the first setting time.

In an exemplary embodiment of the present invention, the main control part may determine the voltage level of the common voltage to be an initial voltage level when the image data of the previous frame is different from the image data of the present frame during the first setting time.

In an exemplary embodiment of the present invention, the display panel driving apparatus may further comprise a representative luminance value calculating part which analyzes the image data stored in the graphic memory to calculate the representative luminance value. The main control part may determine a gray scale for the image data of the present frame using the representative luminance value.

In an exemplary embodiment of the present invention, the display panel driving apparatus may further include; a data drive circuit which outputs a plurality of data signals to a plurality of data lines disposed on the display panel, a gate drive circuit which outputs a plurality of gate signals to a plurality of gate lines disposed substantially perpendicular to the plurality of data lines disposed on the display panel, and a timing generating part which generates a first control signal which controls the data drive circuit and a second control signal which controls the gate drive circuit based on a control signal provided from the main control part.

According to a method of generating a common voltage for driving a display panel, a display panel driving apparatus for performing the method, and a display apparatus having the display panel driving apparatus, a level of the common voltage applied to the display panel in accordance with whether the same image data is received is controlled, thereby preventing afterimages from being generated when the same image is displayed during a predetermined time. Accordingly, the display quality of the display apparatus may be improved.

### BRIEF DESCRIPTION OF THE DRAWINGS

The above and other aspects, features and advantages of the present invention will become more apparent by describing in detailed exemplary embodiments thereof with reference to the accompanying drawings, in which:

FIG. 1 is a schematic top plan view illustrating an exemplary embodiment of a display apparatus according to the present invention;

FIG. 2 is a block diagram illustrating an exemplary embodiment of a display panel driving apparatus of FIG. 1;

FIG. 3 is a block diagram illustrating an exemplary embodiment of a data drive circuit of FIG. 2; and

FIG. 4 is a flowchart showing an exemplary embodiment of a driving method of an exemplary embodiment of a common voltage determining circuit of FIG. 2.

### DETAILED DESCRIPTION OF THE INVENTION

The present invention now will be described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. Like reference numerals refer to like elements throughout.

It will be understood that when an element or layer is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of an apparatus and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

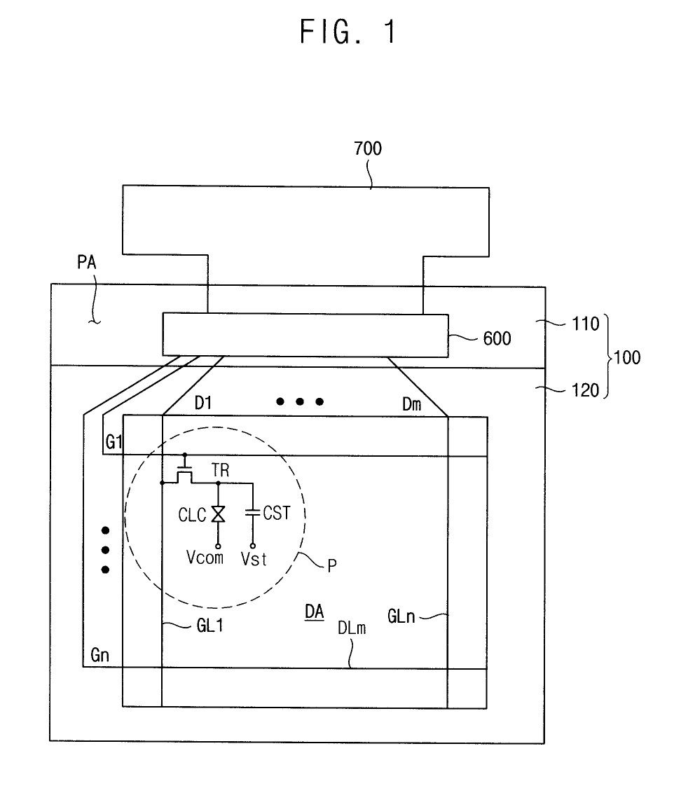

FIG. 1 is a schematic top plan view illustrating an exemplary embodiment of a display apparatus according to the present invention.

Referring to FIG. 1, an exemplary embodiment of a display apparatus includes a display panel 100, a display panel driving apparatus 600 which drives the display panel 100, and a flexible printed circuit board (“FPCB”) 700.

Exemplary embodiments of the display panel 100 may include a display substrate 110, an opposite substrate 120, and a liquid crystal layer (not shown) interposed between the display substrate 110 and the opposite substrate 120. The display panel 110 may include a display area DA and a peripheral area PA surrounding the display area DA.

A plurality of gate lines GL, a plurality of data lines DL and a plurality of pixels P are formed in the display area DA. Each of the pixels P includes a switching element, exemplary embodiments of which include a transistor TR, electrically connected to the gate lines GL and the data lines DL, and a liquid crystal capacitor CLC and a storage capacitor CST that are electrically connected to the transistor TR. The liquid crystal capacitor CLC includes a first terminal connected to a pixel electrode connected to a drain electrode of the transistor TR, and a second terminal connected to a common electrode to which a common voltage Vcom is applied. The storage capacitor CST includes a first terminal connected to the pixel electrode, which is in turn connected to a drain electrode of the storage capacitor CST, and a second terminal connected to a storage line to which the storage voltage Vst is applied. Exemplary embodiments include configurations wherein the storage capacitor CST may be omitted.

In the present exemplary embodiment, the display panel driving apparatus 600 is mounted on the peripheral area PA. The display panel driving apparatus 600 is electrically connected to an external apparatus such as a graphic controller (not shown) through the FPCB 700. Alternative exemplary embodiments include configurations wherein the display panel driving apparatus may be variously mounted on other components, e.g., on the FBCB 700 itself, or on a separate substrate from the display panel 100.

In the present exemplary embodiment, the FPCB 700 is mounted on the peripheral area PA to provide a control signal and a data signal received from the external apparatus to the display panel driving apparatus 600. In one exemplary embodiment, the FPCB 700 includes a first terminal connected to the display panel driving apparatus 600 of the display panel 100, and a second terminal connected to the external apparatus.

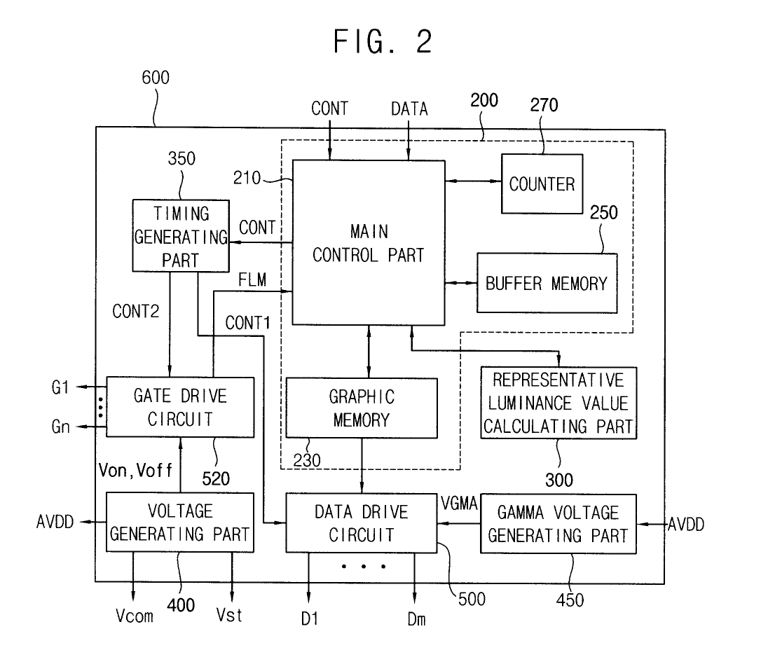

FIG. 2 is a block diagram illustrating an exemplary embodiment of a display panel driving apparatus 600 of FIG. 1.

Referring to FIG. 2, the display panel driving apparatus 600 may include a common voltage determining circuit 200, a representative luminance value calculating part 300, a timing generating part 350, a voltage generating part 400, a gamma voltage generating part 450, a data drive circuit 500 and a gate drive circuit 520.

The common voltage determining circuit 200 compares image data of a previous frame with image data of a present frame to determine whether or not the image data of the previous frame received during a first setting time is substantially the same as the image data of the present frame. The common voltage determining circuit 200 determines a voltage level of the common voltage Vcom applied to the display panel 100 in accordance with whether the image data of the previous frame is substantially the same as the image data of the present frame. The common voltage determining circuit 200 provides the voltage generating part 400 with a common voltage level determining signal CLDS.

The common voltage determining circuit 200 includes a main control part 210, a graphic memory 230, a buffer memory 250 and a counter 270.

The main control part 210 receives a control signal CONT and the image data DATA. The main control part 210 provides the timing generating part 350 with the control signal CONT, and provides the graphic memory 230 with the image data DATA.

The main control part 210 compares image data DATA of the present frame stored in the graphic memory 230 with image data DATA of the previous frame stored in the buffer memory 250 to determine whether or not the image data of the previous frame is substantially the same as the image data of the present frame during the first setting time. Exemplary embodiments include configurations wherein the main control part 210 may compare the image data DATA of the present frame with the image data DATA of the previous frame in a second setting time in addition to, or in the alternative to, the first setting time. For example, exemplary embodiments include configurations wherein the first setting time may be about 3 minutes, and the second setting time may be about 30 minutes.

The main control part 210 may check a frame signal FLM provided from the gate drive circuit 520 to check whether or not the first and the second setting times have passed.

In one exemplary embodiment, the frame signal FLM has substantially the same period as a gate on signal applied to one gate line of the plurality of gate lines GL1 to GLn.

The main control part 210 controls the counter 270 to increase a count value when the image data DATA of the present frame is substantially the same as the image data DATA of the previous frame.

The main control part 210 outputs a reset signal to the counter 270 when the image data DATA of the present frame is different from the image data DATA of the previous frame. The counter 270 reset the count value upon receipt of the reset signal from the main control part 210.

The main control part 210 compares the count values of the counter 270 with a predetermined setting value during the first setting time, and determines the voltage level of the common voltage Vcom to be a common voltage level corresponding to a gray scale of the present frame image. The main control part 210 may recognize the gray scale of the present frame image based on a representative luminance value output from the representative luminance value calculating part 300.

Alternative exemplary embodiments include configurations wherein the main control part 210 determines the voltage level of the common voltage Vcom to be substantially equal to the voltage level of the initially set common voltage when the count value of the counter 270 is less than the predetermined setting value.

In such an exemplary embodiment, the initially set common voltage Vcom may have a voltage level capable of minimizing the generation of afterimages. Accordingly, when the main control part 210 determines that the image data of the present frame is substantially the same as the image data of the previous frame over a predetermined time, the main control part 210 may change the voltage level of the initially set common voltage Vcom to a common voltage level corresponded to the gray scale of the image currently output. On the other hand, when the main control part 210 determines that the image data of the present frame is different from the image data of the previous frame over the predetermined time, the main control part 210 may maintain the voltage level of the initially set common voltage Vcom.

In one exemplary embodiment, the main control part 210 may include a lookup table (“LUT”) in which information about the common voltage level according to the gray scale level is stored. In such an exemplary embodiment, the main control part 210 selects the common voltage level corresponding to the gray scale of the present frame image from the LUT to provide to the voltage generating part 400 when the count value is equal to or greater than the setting value.

The graphic memory 230 stores the image data DATA provided from the main control part 210. In the present exemplary embodiment, the graphic memory 230 may have the size capable of storing the image data DATA corresponding to one frame.

For example, in the exemplary embodiment wherein the display panel 100 has a resolution of 240 pixels×340 pixels, the graphic memory 230 may have a size of 240×23×340. The above is a case in which one unit pixel includes a red (R), a green (G) and a blue (B) sub-pixel and data corresponding to each of the sub-pixels is represented in 8 bits.

The graphic memory 230 provides the data drive circuit 500 with the image data DATA.

The buffer memory 250 stores the image data DATA corresponding to the previous frame. In one exemplary embodiment, the buffer memory 250 has a size capable of storing the image data DATA corresponding to one frame, similar to that of the graphic memory 230, or a size capable of storing the image data DATA corresponding to at least one horizontal line of the image data corresponding to one frame. For example, in an exemplary embodiment wherein the display panel 100 has the resolution of 240×340, the buffer memory 250 may have a size of 240×23 to store the image data DATA corresponding to only the one horizontal line.

The counter 270 increases the count value by 1 in accordance with a control of the main control part 210. The counter 270 outputs the count value to the main control part 210. The counter 270 resets the count value in response to a reset signal provided from the main control part 210.

The representative luminance value calculating part 300 analyzes the image data DATA stored in the graphic memory 230 in accordance with the control of the main control part 210 to calculate the representative luminance value of a frame image. For example, in one exemplary embodiment the representative luminance value calculating part 300 converts RGB data of each of the unit pixels into YIQ data, using the following Equation 1.

$$\vert \begin{matrix}\begin{matrix}Y \\ I\end{matrix} \\ Q\end{matrix} \vert = \vert \begin{matrix}0.299 & 0.587 & 0.114 \\ 0.596 & - 0.274 & - 0.322 \\ 0.211 & - 0.523 & 0.312\end{matrix} \vert \vert \begin{matrix}\begin{matrix}R \\ G\end{matrix} \\ B\end{matrix} \vert \qquad Equation 1$$

When I and Q components representing the chrominance are removed in the YIQ data, only the Y component representing the luminance of each of the unit pixels remains.

The representative luminance value calculating part 300 develops a histogram corresponding to the frame image using the Y component of each of the unit pixels of the frame image. Exemplary embodiments of the representative luminance value calculating part 300 may select a luminance value which has the highest frequency number as the representative luminance value of the frame image in the histogram, or select an average luminance value of the histogram as the representative luminance value of the frame image.

The representative luminance value calculating part 300 outputs the information of the calculated representative luminance value to the main control part 210.

The timing generating part 350 receives the control signal CONT from the main control part 210. Exemplary embodiments of the control signal CONT may include a main clock signal MCLK, a vertical synchronization signal VSYNC, a horizontal synchronization signal HSYNC, a data enable signal DE, and various other similar signals.

The timing generating part 350 generates a first control signal CONT1 for controlling a drive timing of the data drive circuit 500 and a second control signal CONT2 for controlling a drive timing of the gate drive circuit 520 using the control signal CONT received from the common voltage determining circuit 200. Exemplary embodiments of the first control signal CONT1 may include a horizontal start signal STH, a load signal TP and a data clock signal DCLK. Exemplary embodiments of the second control signal CONT2 may include a vertical start signal STV, a gate clock signal GCLK and an output enable signal OE, etc. In addition, the timing generating part 350 generates a gamma control signal GCS for controlling the gamma voltage generating part 450.

The voltage generating part 400 generates drive voltages for driving the display panel 100.

For example, in one exemplary embodiment the voltage generating part 400 generates a gate drive voltage to be applied to the gate drive circuit 520. The gate drive voltage includes a gate-on voltage Von for generating the gate-on signal and a gate-off voltage Voff for generating the gate-off signal. In the present exemplary embodiment, the voltage generating part 400 generates an analog drive voltage AVDD to apply the analog drive voltage AVDD to the gamma voltage generating part 450.

In addition, the voltage generating part 400 generates the common voltage Vcom and the storage voltage Vst to apply both voltages to the display panel 100. The common voltage Vcom is applied to the common electrode formed on the opposite substrate 120 and the storage voltage Vst is applied to the storage line formed on the display substrate. Alternative exemplary embodiments include configurations wherein the storage voltage Vst may be omitted.

The voltage generating part 400 generates the common voltage Vcom corresponding to the common voltage level determining signal CLDS provided from the main control part 210 to apply the common voltage Vcom to the display panel 100.

The gamma voltage generating part 450 generates a plurality of gamma reference voltages VGREF using the analog drive voltage AVDD applied from the voltage generating part 400 as a reference voltage, based on the gamma control signal GCS provided from the timing generating part 350. In one exemplary embodiment, the gamma voltage generating part 450 may generate the plurality of gamma reference voltages VGREF by subdividing the analog drive voltage AVDD through a plurality of resistors connected in series.

The data drive circuit 500 receives the first control signal CONT1 from the timing generating part 350, receives the image data DATA from the graphic memory 230, and receives the gamma reference voltage VGMA from the gamma voltage generating part 450.

The data drive circuit 500 converts the image data DATA into the data signals D1 to Dm, each of which are analog type signals, based on the first control signal CONT1 and the gamma reference voltages VGMA, to output the image data DATA to the data lines DL1 to DLm.

The gate drive circuit 520 generates the gate drive signals G1 to Gn for driving the gate lines GL1 to GLn using the gate drive voltage provided from the voltage generating part 400 and the second control signal CONT2 provided from the timing generating part 350. The gate drive circuit 520 sequentially outputs the gate drive signals G1 to Gn to the gate lines GL1 to GLn.

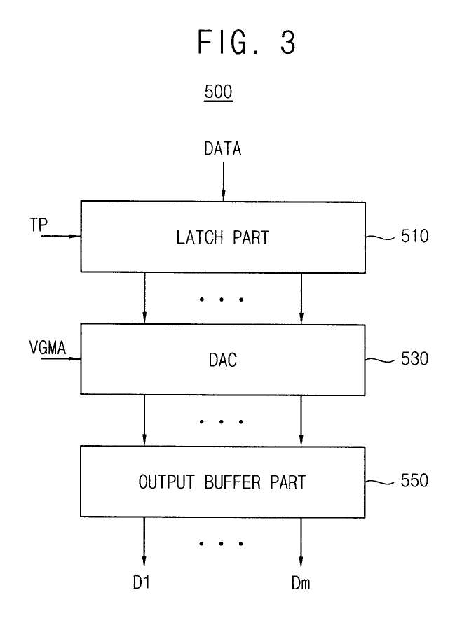

FIG. 3 is a block diagram illustrating an exemplary embodiment of a data drive circuit of FIG. 2.

Referring to FIGS. 2 and 3, the data drive circuit 500 may include a latch part 510, a digital-to-analog converter (“DAC”) 530 and an output buffer part 550.

The latch part 510 latches the image data DATA provided from the graphic memory 230. In one exemplary embodiment, the latch part 510 may be a line latch part which latches the image data DATA provided from the graphic memory 230 as individual lines to output the image data DATA. The latch part 510 outputs the image data DATA of the individual lines latched in response to the load signal TP included in the first control signal CONT1 provided from the timing generating part 350 to the DAC 530.

The DAC 530 converts the image data DATA output from the latch part 420 into the analog-type data signals based on the gamma reference voltage VGMA to output the image data DATA.

In one exemplary embodiment, the output buffer part 550 includes a plurality of unit output buffers, and amplifies the data signal provided from the DAC 530 by a predetermined level to output the data signal to the data lines DL1 to DLm.

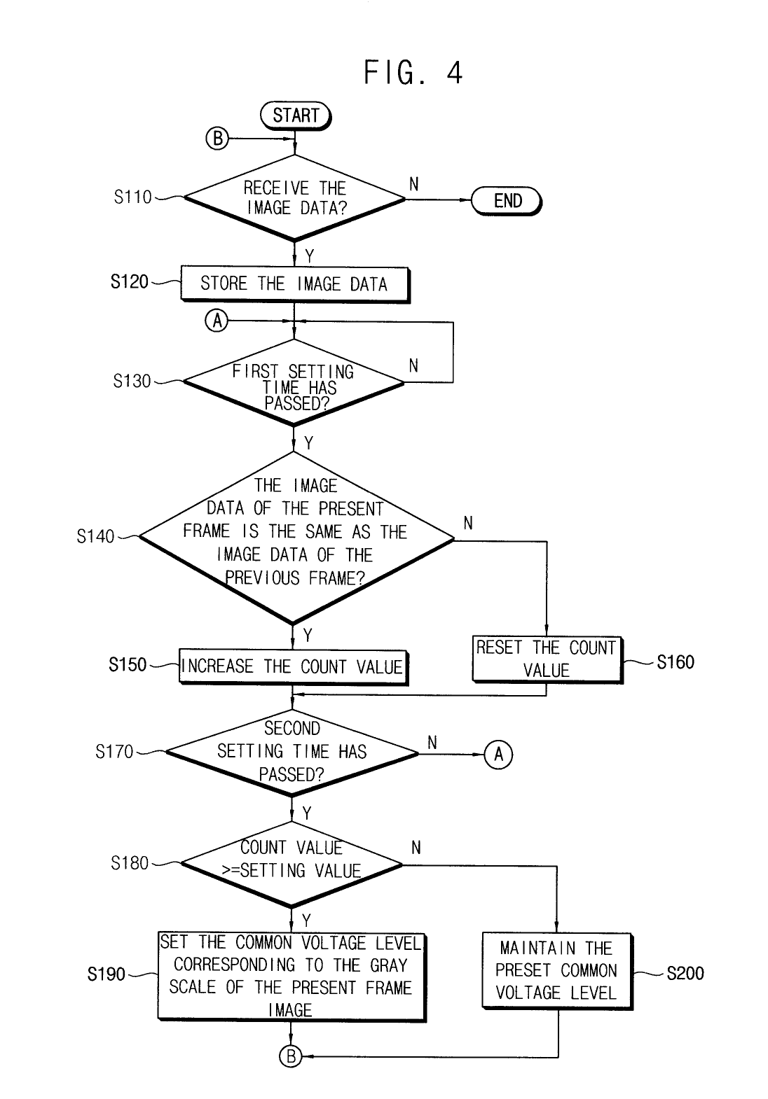

FIG. 4 is a flowchart showing an exemplary embodiment of a driving method of a common voltage determining circuit of FIG. 2.

Referring to FIGS. 2 and 4, the main control part 210 determines whether or not the image data DATA is received from the external apparatus through the FPCB 700 (step S110).

In step S110, when it is determined that the image data DATA is not received, operation of the main control part 210 is ended.

In step S110, when it is determined that the image data DATA is received, the main control part 210 provides the graphic memory 230 with the image data DATA. The graphic memory 230 stores the image data DATA provided from the main control part 210 and the buffer memory 250 stores the image data DATA from the previous frame (step S120).

The main control part 210 determines whether or not the determined first setting time (for example, about 3 minutes) has passed (step S130). The main control part 210 may check whether the first setting time has passed or not based on the frame signal FLM provided from the gate drive circuit 520. Alternative exemplary embodiments include configurations wherein the main control part 210 includes a separate timer or other methods of determining whether the first setting time has passed.

In step S130, when it is determined that the first setting time has passed, the main control part 210 compares the image data DATA of the present frame stored in the graphic memory 230 with the image data DATA of the previous frame stored in the buffer memory 250 to check whether or not both of the image data are substantially the same (step S140).

In step S140, when it is determined that the image data DATA of the present frame is substantially the same as the image data DATA of the previous frame, the main control part 210 controls the counter 270 to increase the count value (step S150). In the present exemplary embodiment, the counter 270 increases the count values by 1 in accordance with the control of the main control part 210.

Alternatively in step S140, when it is determined that the image data DATA of the present frame is not the same to the image data DATA of the previous frame, the main control part 210 outputs the reset signal to the counter 270 (step S150). The counter 270 resets the count value in response to the reset signal provided from the main control part 210.

Next, the main control part 210 determines whether or not the predetermined second setting time (for example, about a half hour) has passed (step S170).

In step S170, when it is determined that the second setting time has not passed, the main control part 210 feedbacks to step S130 to repetitively perform step S140 to step S160 until the second setting time has passed.

Alternatively in step S170, when it is determined that the second setting time has passed, the main control part 210 determines whether the count value counted by the counter 270 is greater than or equal to the predetermined setting value (step S180).

In step S180, when it is determined that the count value is equal to or greater than the predetermined setting value, the main control part 210 outputs the common voltage level determining signal CLDS to the voltage generating part 400 instructing the voltage generating part 400 to set the voltage level of the common voltage Vcom to correspond to the gray scale of the present frame image (step S190), and then returns to step S110. The voltage generating part 400 generates the common voltage Vcom having the voltage level corresponding to the gray scale of the present frame image in response to the common voltage level determining signal CLDS.

Alternatively in step S180, when it is determined that the count value is less than the setting value, the main control part 210 outputs a signal maintaining the voltage level of the determined common voltage Vcom to the voltage generating part 400 (step S200), and then returns to step S110. When it is determined that the count value is less than the predetermined setting value, the main control part 210 may apply no signal to the voltage generating part 400.

As described above, according to the exemplary embodiments of the present invention, a level of a common voltage applied to a display panel in accordance with whether or not the same image data is received during a predetermined time is controlled, thereby preventing the generation of afterimages when the same image is displayed for longer than a predetermined time. Accordingly, the display quality of the image may be improved.

The foregoing is illustrative of the present invention and is not to be construed as limiting thereof. Although a few exemplary embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method of generating a common voltage for driving a display panel, the method comprising:
comparing image data of a previous frame with image data of a present frame to determine whether the image data of the previous frame, which is received during a first setting time, is substantially the same as the image data of the present frame;
determining a voltage level of the common voltage applied to the display panel in accordance with whether the image data of the previous frame is substantially the same as the image data of the present frame;
generating the common voltage corresponding to the determined voltage level; and
providing the display panel with the common voltage.

2. The method of claim 1, wherein comparing image data of a previous frame with image data of a present frame is performed during a second setting time.

3. The method of claim 1, wherein determining the voltage level of the common voltage comprises:
increasing a count value when the image data of the previous frame is substantially the same as the image data of the present frame; and
comparing the count value with a predetermined setting value after a second setting time;
determining the voltage level of the common voltage to be a common voltage level corresponding to a gray scale of the image data of the present frame when the count value is equal to or greater than the predetermined setting value.

4. The method of claim 3, wherein determining the voltage level of the common voltage further comprises:
resetting the count value when the image data of the previous frame is different from the image data of the present frame.

5. The method of claim 4, wherein determining the voltage level of the common voltage includes determining the voltage level of the common voltage to be an initial voltage level when the count value is less than the predetermined value.

6. A display panel driving apparatus comprising:
a common voltage determining circuit which compares image data of a previous frame with image data of a present frame to determine whether the image data of the previous frame received during a first setting time is substantially the same as the image data of the present frame, and which determines a voltage level of a common voltage applied to a display panel in accordance with whether the image data of the previous frame is substantially the same as the image data of the present frame; and
a voltage generating part which generates the common voltage corresponding to the determined voltage level to provide the display panel with the common voltage.

7. The display panel driving apparatus of claim 6, wherein the common voltage determining circuit compares the image data of the previous frame with the image data of the present frame during a second setting time.

8. The display panel driving apparatus of claim 7, wherein the common voltage determining circuit comprises:
a buffer memory which stores the image data of the previous frame;
a graphic memory which stores the image data of the present frame; and
a main control part which determines the voltage level of the common voltage to be a common voltage level corresponding to a gray scale of the image data of the present frame when the image data of the previous frame is substantially the same as the image data of the present frame during the first setting time.

9. The display panel driving apparatus of claim 8, wherein the main control part determines the voltage level of the common voltage to be an initial voltage level when the image data of the previous frame is different from the image data of the present frame during the first setting time.

10. The display panel driving apparatus of claim 9, further comprising a representative luminance value calculating part which analyzes the image data stored in the graphic memory to calculate a representative luminance value,
wherein the main control part determines a gray scale of the image data of the present frame using the representative luminance value.

11. The display panel driving apparatus of claim 9, wherein the common voltage determining circuit further comprises a counter which outputs a count value, and
the main control part controls the counter to increase the count value when the image data of the previous frame is substantially the same as the image data of the present frame.

12. The display panel driving apparatus of claim 11, wherein the main control part outputs a reset signal to the counter to reset the count value when the image data of the previous frame is different from the image data of the present frame.

13. The display panel driving apparatus of claim 11, wherein the main control part compares the count value with the predetermined setting value, and when the count value is less than the predetermined value the main control part determines the image data of the previous frame to be substantially the same as the image data of the present frame during the first setting time.

14. A display apparatus comprising:
a display panel which displays an image; and
a display panel driving apparatus comprising:
a common voltage determining circuit which compares image data of a previous frame with image data of a present frame to determine whether the image data of the previous frame received during a first setting time is substantially the same as the image data of the present frame, and which determines a voltage level of a common voltage applied to the display panel in accordance with whether the image data of the previous frame is substantially the same as the image data of the present frame; and
a voltage generating part which generates the common voltage corresponding to the determined voltage level to provide the display panel with the common voltage.

15. The display apparatus of claim 14, wherein the common voltage determining circuit compares the image data of the previous frame with the image data of the present frame during a second setting time.

16. The display apparatus of claim 15, wherein the common voltage determining circuit comprises:
a buffer memory which stores the image data of the previous frame;
a graphic memory which stores the image data of the present frame; and
a main control part which determines the voltage level of the common voltage to be a common voltage level corresponding to the gray scale of the image data of the present frame when the image data of the previous frame is substantially the same as the image data of the present frame during the first setting time.

17. The display apparatus of claim 16, wherein the main control part determines the voltage level of the common voltage to be an initial voltage level when the image data of the previous frame is different from the image data of the present frame during the first setting time.

18. The display apparatus of claim 17, wherein the display panel driving apparatus further comprises a representative luminance value calculating part which analyzes the image data stored in the graphic memory to calculate the representative luminance value, and
the main control part determines a gray scale for the image data of the present frame using the representative luminance value.

19. The display apparatus of claim 18, wherein the display panel driving apparatus further comprises:
a data drive circuit which outputs a plurality of data signals to a plurality of data lines disposed on the display panel;
a gate drive circuit which outputs a plurality of gate signals to a plurality of gate lines disposed substantially perpendicular to the plurality of data lines disposed on the display panel; and
a timing generating part which generates a first control signal which controls the data drive circuit and a second control signal which controls the gate drive circuit based on a control signal provided from the main control part.
